(19) United States
(12) Patent Application Publication
(10) Pub. No.: US 2011/0148649 A1
(43) Pub. Date: Jun. 23, 2011

(54) Proximity Sensor Enabled Electromagnetic Service Connector System

(75) Inventors: Daniel de Cavalcanti, Saint Joseph, MI (US); Richard A. McCoy, Stevensville, MI (US)

(73) Assignee: WHIRLPOOL CORPORATION, Benton Harbor, MI (US)

(21) Appl. No.: 12/643,254

(22) Filed: Dec. 21, 2009

(51) Int. Cl. G08B 21/00; H02J 17/00

(52) U.S. Cl. 340/686.6; 307/104

(57) ABSTRACT

An electromagnetic service connector system and components for providing or receiving an electromagnetic service, such as power or data. An electromagnetic service switch is provided for selectively transferring the electromagnetic service from the host or other electromagnetic service source to the electromagnetic service consumer. The electromagnetic service switch is activated to transfer an electromagnetic service in response to detection of a proximity target associated with an electromagnetic service consumer by a proximity source associated with an electromagnetic service provider.

### BACKGROUND

Traditionally, appliances, consumer electronics devices, and other useful household equipment are located in a room dedicated to the function supported by the appliance, consumer electronic device, and/or household equipment. For example, the kitchen has traditionally been limited to a space for preparing and eating meals and consequently has mostly been occupied by cabinetry and large home appliances such as refrigerators, dishwashers, and ovens. The family room has been designated as a place for leisure activities, and so most entertainment devices, such as televisions and video games are commonly found here. Laundry rooms normally house a washer, dryer, and iron. Devices such as personal computers and printers are often located in another room, such as a dedicated home office or bedroom.

Consumers increasingly own multiple hand-held or portable consumer electronic devices, such as laptops, cell phones, PDA's, and digital music players. These devices are typically used in many different rooms in the house and are often carried from room to room throughout the home. Consumers also tend to perform nontraditional tasks in the traditional rooms of the home. For example, consumers also tend to eat in the living room or media room, instead of the dining room. Consumers tend to eat, meet and entertain in the kitchen, not just in the dining room and family room. In fact, the kitchen is often the hub of most household activity. Consumers also tend to work in every room of the home with the adoption of laptop computers and wireless networks. Therefore, there is a trend for consumers to perform non-traditional functions in a household room designed for a traditional function. The present invention recognizes this trend and attempts to support the trend.

### BRIEF SUMMARY

The invention relates to electromagnetic service connector systems for selectively providing electromagnetic service, such as data or power, between electromagnetic service connector components, for example in connecting a portable device to a host.

According to one aspect of the invention, a system for coupling to an electromagnetic service communicating device includes an electromagnetic service connector system. The electromagnetic service connector system has a first electromagnetic service connector component associated with an electromagnetic service communicating device and operably engageable with a second electromagnetic service connector component associated with an electromagnetic service source, an electromagnetic service pathway between the first and second electromagnetic service connector components when the electromagnetic service components are interengaged, the electromagnetic service pathway being capable of passing an electromagnetic service between the first and second electromagnetic service connector components, and an electromagnetic service switch operably associated with a proximity sensor of the second electromagnetic service connector component to selectively permit the flow of the electromagnetic service along the electromagnetic service pathway when the proximity sensor detects a proximity target of the first electromagnetic service connector component.

According to another aspect of the invention, an electromagnetic service connector system includes an electromagnetic service connector component, a proximity sensor capable of detecting a proximity target, an electromagnetic service pathway interconnecting an electromagnetic service source and the electromagnetic service connector component, and an electromagnetic service switch selectively permitting the flow of the electromagnetic service along the electromagnetic service pathway in response to detection of a proximity target by the proximity sensor.

According to yet another aspect of the invention, an electromagnetic service consumer comprises an electromagnetic service connector component, an electromagnetic service pathway for interconnecting an electromagnetic service consumer and the electromagnetic service connector component, and a proximity target capable of activating a proximity sensor to activate an electromagnetic service switch.

According to still another aspect of the invention, and adapter comprises a second host electromagnetic service connector component engageable with a first host electromagnetic service connector component on a host, a second device electromagnetic service connector component engageable with a first device electromagnetic service connector component on a portable electromagnetic service communicating device, an electromagnetic service pathway interconnecting the second host electromagnetic service connector component and the second device electromagnetic service connector component for the transfer of an electromagnetic service therealong, and a second contactless proximity coupling device operably associated with the second host electromagnetic connector component, the second contactless proximity coupling device being configured to engage a first contact proximity coupling device when the first and second electromagnetic connector components are engaged to selectively permit the communication of the electromagnetic service between the first electromagnetic communicating device and the second electromagnetic service communicating device.

### BRIEF DESCRIPTION OF THE DRAWINGS

In the drawings:

FIG. 1 is a perspective view of a modular system according to one embodiment of the invention employing a proximity sensor enabled electromagnetic service connector system for connecting an accessory device to a host.

FIG. 2 is a front elevational view of the modular system of FIG. 1, showing the accessory devices attached to the host.

FIG. 3 is a side elevational view of the modular system of FIG. 1, showing the accessory devices removed from the host.

FIG. 4 is partial top rear perspective view of the modular system of FIG. 1 with the accessory device removed from the host, showing a host portion of the exemplary proximity sensor enabled electromagnetic service connector system, with portions shown schematically.

FIG. 5 is bottom perspective view of the accessory device of FIG. 1 showing an accessory device portion of the proximity sensor enabled electromagnetic service connector system.

FIG. 6 is a partial cross-sectional view of the proximity sensor enabled electromagnetic service connector system of FIG. 1 using a magnetic proximity target and a magnetic proximity sensor, shown with the accessory device portion of the electromagnetic service connector system positioned for engagement with the host portion of the electromagnetic service connector system.

FIG. 7 is a partial cross-sectional view similar to FIG. 6, showing the accessory device portion of the electromagnetic service connector system engaged with the host portion of the electromagnetic service connector system.

FIG. 8 is a partial cross-sectional view of a modular system according to a second embodiment of the invention employing a proximity sensor enabled electromagnetic service connector system using an unpowered electromagnetic service switch and showing the accessory device portion of the electromagnetic service connector system positioned for engagement with the host portion of the electromagnetic service connector system.

FIG. 9 is a partial cross-sectional view of the proximity sensor enabled electromagnetic service connector system of FIG. 8, showing the accessory device portion of the electromagnetic service connector system engaged with the host portion of the electromagnetic service connector system.

FIG. 10 is a partial cross-sectional view of a modular system according to a third embodiment of the invention employing a proximity sensor enabled electromagnetic service connector system using a powered electromagnetic service switch and showing the accessory device portion of the electromagnetic service connector system positioned for engagement with the host portion of the electromagnetic service connector system.

FIG. 11 is a partial cross-sectional view of the proximity sensor of FIG. 10, showing the accessory device portion of the electromagnetic service connector system engaged with the host portion of the electromagnetic service connector system.

FIG. 12 is a partial cross-sectional view of a modular system according to a fourth embodiment of the invention employing a proximity sensor enabled electromagnetic service connection system for delivering a contactless service, showing the accessory device portion of the electromagnetic service connection system engaged with the host portion of the electromagnetic service connection system.

FIG. 13 is a generalized schematic illustration of a first electromagnetic service communicating device having a first electromagnetic service connector component and a second electromagnetic service communicating device having a second electromagnetic service connector component capable of engaging the first electromagnetic service connector for the communication of service therebetween.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or to otherwise limit or restrict the claims to the precise forms and configurations shown in the drawings and disclosed in the following detailed description.

The drawings and the following detailed description relate generally to systems of electromagnetic service connector components for coupling an electromagnetic service provider with an electromagnetic service consumer. The following definitions apply to terms that may be used in the specification and the claims, unless otherwise noted.

As used herein, an “electromagnetic service” is electrical power or data. An electromagnetic service may comprise multiple categories of service, such as electrical power and data in a single signal. An electromagnetic service may be provided continuously, for specified times, for specified amounts, or for the duration of certain events, such as the duration of coupling to provide timed dispensing. Alternatively, an electromagnetic service may be provided in quanta, such as packets of data.

The term “coupled” and any variation thereof, as used herein, includes any type of connection that permits transfer of a service, as hereinafter defined, between two devices. The term “coupled” does not require a physical connection between the two devices so long as the coupling permits transfer of a service. The term “coupled” includes both fixed and removable coupling, as well as both continuous and intermittent coupling.

“Wireless” refers to a type of communication in which power and/or data is transferred over a distance without the use of electrical conductors or wires. For example, electromagnetic waves, light waves, or acoustic waves can be used to carry power and/or data over a distance without using electrical conductors or wires.

“Electrical power communication” is the coupling of two devices to supply electrical power from at least one of the devices to the other of the devices, such as through directly connected electronic lines or through wireless power communication (also referred to as wireless power transmission). Wireless power communication may include any type of wireless power communication, including, without limitation for illustration purposes, microwave transmission, laser transmission, and magnetic fields. Exemplary categories of power communication include the type of power, e.g. alternating current (also known as AC) or direct current (also known as DC), supplied to a functional device (defined below) and variations in the characteristics of the power, such as the voltage or current.

“Data communication” is the coupling of two devices to transmit data from at least one of the devices to the other of the devices, such as through directly connected electronic lines or through wireless data communication (also referred to as wireless data transmission). The data may be transmitted as a separate signal or embedded in electrical power communication. Wireless data communication may include any type of wireless data communication, including, without limitation for illustration purposes, wireless network (a/k/a Wi-Fi), radio transmission, light transmission, and acoustical transmission. Exemplary categories of data communication include encrypted and unencrypted data. Data communication also includes communication for different protocols, including physical layer protocols and software layer protocols. Examples of physical layer protocols are a wired Ethernet and a wireless (Wi-Fi) network, both of which may support the same data packet structure. Examples of software layer protocol are Zigbee® and Bluetooth®. Data communication may also be completed by way of an analog mechanical transmission means such as by means of fluidic pulses created by positive pressure systems or vacuum systems or by a mechanical logic transfer means, such as the throwing of switches or levers to actuate or transmit information about a control state.

“Communicating” an electromagnetic service, and any variation thereof, as used herein, means supplying or receiving an electromagnetic service. As used herein, communication of electromagnetic service includes both uni-directional and multi-directional communication between any two devices, either directly or through an adapter, as defined herein.

The terms “provide” and “supply” and any variation thereof, are used herein to denote a source of the electromagnetic service relative to a device receiving the electromagnetic service. Neither term is limited to the original source of the electromagnetic service. A device that provides or supplies the electromagnetic service may simply be passing on the electromagnetic service from the original source, such as a residential power utility system or the internet. For example, a device that provides an electrical power service may pass on electricity it receives from a household outlet. However, the device may, alternatively or additionally, provide another electromagnetic service that originates with the device, such as a data service.

The term “receive” and any variation thereof, is used herein to denote receipt of the electromagnetic service relative to the device providing the electromagnetic service. The term is not limited to the ultimate consumer of the service. A device that receives the electromagnetic service may simply be passing on the electromagnetic service from the source, such as an appliance, to a device that will consume, as hereinafter defined, the electromagnetic service. The device which receives an electromagnetic service is not necessarily the end consumer of the electromagnetic service.

The term “consume” and any variation thereof, as used herein, denotes the act of employing or dispensing at least a portion of the electromagnetic service received in connection with performing a function, such as using a power service to operate a speaker or video display.

A “useful device” as used herein is a device that is capable of performing a useful physical or virtual function either alone or in combination with another device.

An “electromagnetic service consumer” as used herein is any useful device that employs, uses, stores, or dispenses an electromagnetic service in connection with performing a physical or virtual function. An electromagnetic service consumer may be, for example, a consumer electronic device, a client software device, a remote user interface, a source of consumer information, a reader, such as a bar code, optical scanner or RFID reader, a sensor device, a smart utensil, an appliance, an additional smart coupling device, a remote controller, a network binder, a cycle accessory, a resource controller, such as an energy controller, a communicator, such as an audible accessory, an access or payment system, such as a smart card system permitting access to a host device, a sales demonstration device, an electromagnetic service holder, such as a battery, a dispenser, a media content holder, or an electromagnetic service device, such as a laptop or other service client.

An “electromagnetic service provider” as used herein is any useful device that is capable of providing or supplying an electromagnetic service to another device.

An “electromagnetic service communicating device” as used herein is any useful device that is capable of communicating an electromagnetic service with another device, and may be an electromagnetic service provider or an electromagnetic service consumer.

A “host” as used herein is an electromagnetic service provider that has a primary function independent of providing an electromagnetic service. For example, the host may be an appliance and the primary function may be performing a series of steps to conduct a useful cycle of operation. The appliance may be a conventional household appliance, such as a refrigerator performing a cooling cycle or an ice making cycle. Other examples of appliances that may be hosts include, but are not limited to, a freezer, a conventional oven, a microwave oven, a dishwashing machine, a stove, a range, an air conditioner, a dehumidifier, a clothes washing machine, a clothes dryer, a clothes refreshing machine, and a non-aqueous washing apparatus, or any combination thereof. Alternatively, the host may be a fixture such as a water softener, a water heater, a furnace, pool water treatment equipment, or an HVAC system. The host may be a small device such as a thermostat, a blender, a mixer, a toaster, a coffee maker, an air purifier, an iron, a vacuum cleaner, a robot, or a trash compactor. The host may alternatively comprise a structural feature of a building, such as a wall, a cabinet, or a door. The host may also provide other services, such as mechanical power, illumination, heat, or sound. The host may be an electromagnetic service consumer. For example, a host may provide a power service while receiving or while receiving and supplying a data service.

A “functional device” as used herein is a useful device that may be an electromagnetic service provider, an electromagnetic service consumer, or both.

As used herein, the terms “accessory” or “accessory device” refer to any useful device that may be used primarily in conjunction with a host to enhance, supplement, regulate or monitor the functionality of the host. An accessory device may be a service provider, a service consumer, or both. Examples of an accessory device include, but are not limited to, a television, a video camera, a video recorder, a personal computer, a notebook computer, a computer monitor, a video display, a keyboard, a printer, copying equipment, a calculator, a facsimile machine, a scanner, a digital storage device, a wireless transceiver, an internet router, a power supply, a data recorder, an answering machine, a telephone, a cordless telephone, a cellular telephone, a video game system, a personal digital assistant, a DVD player, a VHS player, a VCR, a cassette deck, an 8 mm video player, a CD player, a Blackberry®, a smartphone, a smoke detector, a portable digital video player, an MP3 player, a radio, other music players, an audio speaker, a digital picture frame, a weather station, and a scale or balance.

A “portable device” as used herein is a device that is designed to be moveable by a user during its useful life between a use location and a storage location or alternative use location. A portable device can be an accessory device.

An “independent device” as used herein is a useful device that provides a useful function without being connected to a service provider. In some cases, the primary function of the independent device is different from the primary function of the host from which the independent device may receive a service. The independent device may be a consumer electronic device, such as portable communication, entertainment, informational or educational devices.

A “dependent device” as used herein is a useful device that provides a useful function only when connected to a service provider. A dependent device may be a service consumer. Examples of dependent service consumers that may be coupled to a host include a remote user interface (UI), a consumable reader, a cooking sensor, a smart pan or pot, a smart dimmer, a cycle accessory, an energy controller, an audible accessory, a laundry payment or smart card system, a sales demonstration unit, or a service laptop or other service client.

An “electromagnetic service connector system” as used herein is a connector system having at least two separate electromagnetic service connector components, each associated with a useful device. The electromagnetic service connector components cooperate with one another to couple the useful devices to facilitate communication of an electromagnetic service between the useful devices. A service connector system may carry multiple services.

A “switched electromagnetic service connector system” as used herein is an electromagnetic service connector system having a switching capability in at least one of the electromagnetic service connector components operable to selectively permit the communication of an electromagnetic service between the components of the electromagnetic service connector system. Since a service connector system may carry multiple services, a switched electromagnetic service connector system may selectively permit the communication of different services.

An “electromagnetic service switch” as used herein is a switch that selectively responds to the detection of a proximity target, defined below, being within a predetermined distance of a proximity sensor. In response to the detection, the electromagnetic service switch regulates the provision of an electromagnetic service and selectively facilitates the communication of an electromagnetic service between components of an electromagnetic service connector system, such as by drawing the components into engagement or by permitting the flow of an electromagnetic service to one of the components for transfer to the other of the components. An electromagnetic service switch may be associated with more than one type of service.

A “proximity target” as used herein is any component or device that may be detected when positioned within a predetermined distance of an associated proximity sensor, defined below. A proximity target may be passive, such as a visual target or a magnetic target formed of magnetic or magnetic responsive material. Other examples of passive proximity targets may include a conductive component or surface capable of cooperating with a magnetic field, a current, or a voltage provided by a proximity sensor. A proximity target may alternatively be active or powered such as an electromagnet, a generator of a magnetic field, a current, a voltage or an acoustic wave. An active proximity target may alternatively provide a powered readable display or dispense a detectable chemical.

A “proximity sensor” as used herein is any component or device that may detect an associated proximity target when the proximity target is within a predetermined distance of the proximity sensor. A proximity sensor may detect, for example, a change in an electromagnetic field, an electromagnetic wave, an acoustic wave, a visual target, a chemical component, an electrical signal, a change in voltage, a change in current, a change in frequency, a change in resistance, a change in inductance, a change in capacitance, a mechanical signal, a change in pressure, a displacement, a vibration, and the presence of a chemical. A proximity sensor may be active or passive, such as a magnetic sensor of magnetic or magnet responsive material, or may alternatively be active. Examples of active sensors include active magnetic sensors, light sensors, optical sensors, acoustic sensors, electromagnetic sensors, chemical sensors and thermal sensors. Examples of magnetic sensors include magnets and magnetic responsive components. Examples of optical sensors include infrared sensors, photoelectric sensors, fiber optic sensors, photo resistors, photovoltaic sensors, photo diodes and cameras. Examples of electromagnetic sensors include radio receivers, radar sensors, Hall Effect sensors, inductive sensors, capacitive sensors, variable reluctance sensors and eddy current sensors. Examples of acoustic sensors include ultrasonic sensors and microphones. A contact proximity sensor detects a proximity target by touching the proximity target. A contactless proximity sensor detects the proximity target through a wireless or contactless means. For example, magnetic flux can be used as the signaling mechanism between a contactless proximity sensor and a contactless proximity target.

As used herein, the term “proximity system” is a system that uses a “proximity switch” operated by a plurality of “proximity coupling components,” each associated with a different parent device, for determining that the parent devices are in proximity with each other. Parent devices are usually paired, examples of which include a service provide and a service consumer, a host and an accessory device, and a host and an adapter. Proximity coupling components may include a proximity target associated with one parent device to actively or passively provide an indication of the presence of the one parent device and a proximity sensor associated with the other parent device, responsive to the presence of the proximity target to activate the proximity switch. The proximity switch may be used to provide a signal or message indicative of the proximity of two parent devices or may directly or indirectly regulate the flow of a service along a service line. The systems disclosed herein can employ contactless proximity systems, wherein the proximity target and proximity switch use contactless or wireless means to detect the proximity of the two parent devices.

A “plug” as used herein is a generally male electromagnetic service connection component.

A “receptacle” as used herein is a generally female electromagnetic service connection component.

An “electromagnetic service pathway” as used herein is any pathway, such as an electromagnetic service line for power or data, for transferring an electromagnetic service from one location to another. The electromagnetic service line may have any of a variety of configurations depending on the type of electromagnetic service being transferred, including, but not limited to, a pipe, a conduit, a wire, a tube, a channel, a fiber optic cable, and a mechanical linkage. For example, to transfer electrical power or data service communication, an electromagnetic service pathway may be an electromagnetic service line such as an electrically conductive wire, an optical data cable, or a wireless transmission system.

As used herein, unless otherwise dictated by the context, “wireless” and “contactless” shall each mean any form of communication or any communication line for which there is a gap between the components through which the electromagnetic service travels, such as by wireless electromagnetic or acoustic wave transmission or a matter flowing through the air across the gap.

An “adapter” as used herein is an intermediate device that may be provided between a first and second useful device, such as between a host and an accessory, to facilitate the communication of services between the first and second useful devices. An adapter may receive an electromagnetic service from the first useful device and provide a modified version of the electromagnetic service to the second useful device, for example, by providing an electrical power service using a different voltage or providing a data service using a different data structure or signal type. In some applications, multiple adapters may be interposed between two useful devices. In other applications, three or more useful devices may be coupled to a single adapter, such as between a host and two accessories. In some applications, the adapter may itself be a functional device providing a useful function not provided by the useful devices coupled to it. An adapter may optionally include a transformative component that transforms a service from a service provider to a different service, which is supplied to a service consumer. This may be useful when the service from the service provider is not compatible with the service consumer. The transformative component can be configured to transform the service into a compatible form for the service consumer. Examples of transformative components are protocol converters, power transformers, or other devices that convert substance, energy, or data from a first form to a second form.

A “functional unit” as used herein is any adapter coupled to a useful device, which together provide a functionality that neither the adapter nor the useful device may alone provide. Any functional unit itself is also included within the meaning of the term “useful device”. In some cases, it is contemplated that a dependent device may be coupled with an adapter that provides one or more services required by the dependent device to enable the functional unit to provide a useful function, in which case the functional unit also constitutes an independent device.

A “storage device” as used herein is any device capable of receiving a service, storing the service, and selectively dispensing the service. A storage device may include, for example, s battery, a capacitor, a hard disk drive, an optical disc, such as CD, DVD, or Blue-ray Disc, a floppy disk, a ZIP disk, a minidisk, a solid state semiconductor memory, such as xD-Picture card, a MultiMediaCard, a USB flash drive, SmartMedia, an SD card, a miniSD card, an SDHC card, a microSD card, a TransFlash card, a CompactFlash I or II, a Secure Digital, or a Sony Memory Stick.

A “conversion device” as used herein is any device capable of converting the form of an electromagnetic service, or converting one electromagnetic service to another service. Examples of a conversion device include, but are not limited to, a generator, a motor, a piezoelectric device, a pneumatic device, an inverter, a lens, a filter, a prism, a transmitter, a speaker, and a resonator.

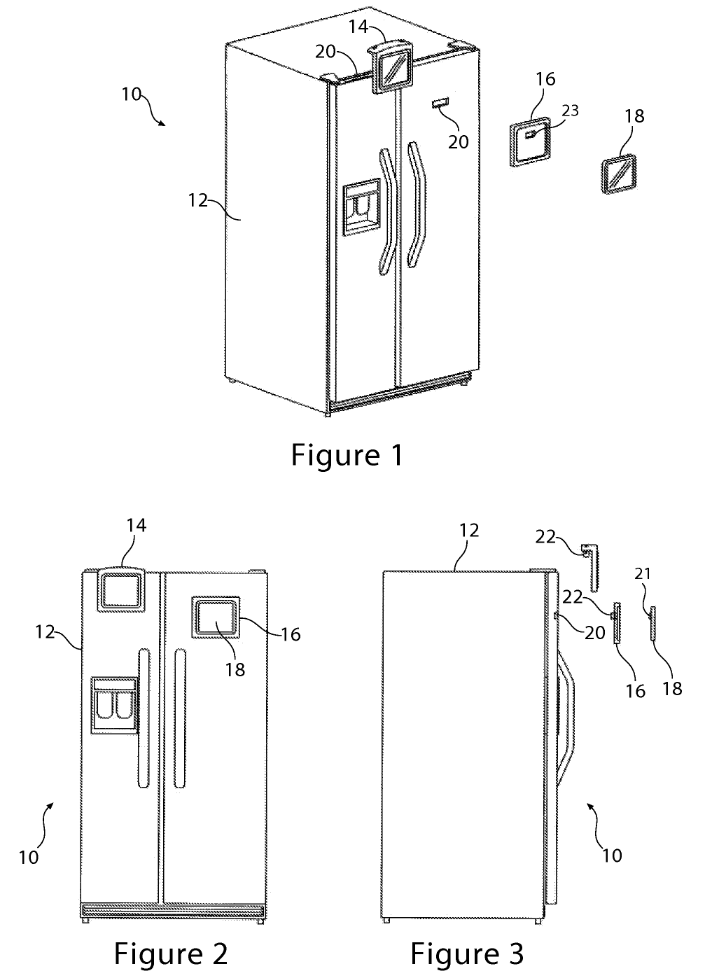

Referring now to FIGS. 1-3, a schematic illustration of a modular system 10 according to one embodiment of the invention is shown to include at least one electromagnetic service provider and at least one electromagnetic service consumer. As illustrated herein, the electromagnetic service provider is a host 12 and the electromagnetic service consumer is an accessory device 14 that may be coupled to host 12.

The accessory device 14 may be either directly or indirectly coupled to host 12. Direct coupling occurs when accessory device 14 includes an electromagnetic service connector component suitably configured for engaging a corresponding electromagnetic service connector component of host 12 to establish an electromagnetic service pathway between the host 12 and the accessory device 14. The electromagnetic service pathway provides a line for transferring at least one electromagnetic service from host 12 to accessory device 14 and from accessory device 14 to host 12.

An adapter 16 may be provided for coupling a second accessory device 18 having an incompatible electromagnetic service connector component to host 12. An electromagnetic service connector component is incompatible if it cannot be directly coupled to a corresponding electromagnetic service connector component, such as when the incompatible electromagnetic service connector component lacks certain physical features that would enable the electromagnetic service connector component to engage the corresponding connector component to establish an electromagnetic service pathway. Adapter 16 may include an electromagnetic service connector component that may be directly coupled with the electromagnetic service connector component of host 12 and a second electromagnetic service connector component that may be directly coupled with the incompatible electromagnetic service connector component of accessory device 18, thereby establishing an electromagnetic service pathway between host 12 and accessory device 18.

Although accessory device 14 is shown coupled to an upper surface of host 12, whereas accessory device 18 is shown attached to a front surface of host 12 by way of adapter 16, it shall be appreciated that in practice, accessory device 14 and adapter 16 may be suitably configured for coupling to host 12 in any desired location and manner in order to accommodate the design and performance requirements of a particular application.

Host 12 may perform a primary function. As illustrated herein, host 12 is a refrigerator performing a cooling cycle and/or an ice making cycle. Although the figures show an appliance comprising a refrigerator, it shall be understood that the invention is not limited to refrigerators or appliances in general.

Accessory devices 14 and 18 may also perform at least one primary function. The primary functions of accessory devices 14 and 18 can be different from the primary function performed by host 12, although they need not be.

Host 12 may be configured to provide or receive at least one electromagnetic service to or from accessory devices 14 and 18. Similarly, accessory devices 14 and 18 may also be configured to provide or receive at least one electromagnetic service to or from host 12. It is not necessary that the electromagnetic service transferred between host 12 and accessory devices 14 and 18 be used in performing the primary function of host 12 or accessory devices 14 and 18, or otherwise be related to the primary function of either accessory device.

As mentioned previously, in instances where the accessory device includes an incompatible electromagnetic service connector component that prevents direct coupling of the accessory device to host 12, adapter 16 may be provided for indirectly coupling the accessory device to host 12. Adapter 16 operates to establish an electromagnetic service pathway for transferring the desired electromagnetic service between host 12 and accessory device 18 having the incompatible electromagnetic service connector component.

At least one electromagnetic service may be supplied to accessory devices 14 and 18 from host 12, or from accessory devices 14 and 18 to host 12. The supply of the electromagnetic service may be uni-directional in that either host 12 supplies the electromagnetic service to accessory devices 14 and 18 or accessory devices 14 and 18 supply the electromagnetic service to host 12. The supply of the electromagnetic service may also be bi-directional in that the supplied electromagnetic service may be delivered from host 12 to accessory devices 14 and 18 and from accessory devices 14 and 18 to host 12.

Exemplary services that may be transferred between host 12 and accessory devices 14 and 18 may include electrical energy and data communication, among others. Data communication may include the transfer of information by way of appropriate transfer media including but not limited to electrical, electromagnetic wave, acoustic and optical data between host 12 and accessory device 14. For example, host 12 may include a modem for enabling internet access to the World Wide Web. Accessory device 14 may also include an electronic device, such as a computer, PDA, digital music player, among others, which when coupled to host 12 may access various forms of data available from the World Wide Web through the modem and have the data transferred from host 12 to accessory device 14. Electrical energy may include electric current such as alternating current, direct current, or both. Electric current may, for example, be transferred from host 12 to accessory device 14 for powering the accessory device 14. It is not necessary that host 12 be the source of the electric current. Host 12 may be operating as a line for transferring electric current received from an outside source, such a community electric service. It shall be appreciated that these are only a few examples of the various types of services that may be transferred between host 12 and accessory devices 14 and 18.

It will further be appreciated that, while the exemplary embodiments in the drawings illustrate specific types of exemplary electromagnetic service communicating devices, such as a host 12 that may operate as an electromagnetic service provider, an accessory device 14 that may operate as an electromagnetic service consumer, and an adapter 16 that may act as a conduit for the transfer of electromagnetic service from host 12 to accessory device 18, variations from this configuration are possible. These variations include systems with only two electromagnetic service communicating devices, systems with more than three electromagnetic service communicating devices, systems where any of the devices may be service consumers and/or service providers, systems where multiple services are communicated and systems where services are received by one device, converted in some manner, and then passed to a third device. Furthermore, in the following description, certain components of connector systems and proximity systems are described for the illustrative purposes as being associated with specific exemplary electromagnetic service communicating devices. For example, a proximity switch, target or sensor may be described as being located in a service provider, service consumer, host or portable device. It will be appreciated that these system components may be alternatively assigned to the various electromagnetic service communicating devices depending on the application.

Host 12 and accessory device 14 may each comprise at least one electromagnetic service connector component, respectively referred to herein as a host electromagnetic service connector component 20 and a device electromagnetic service connector component 22. Host electromagnetic service connector component 20 and device electromagnetic service connector component 22 have complementary configurations that enable the electromagnetic service connector components to be coupled to one another, thereby establishing an electromagnetic service pathway over which desired services may be transferred between host 12 and accessory device 14.

Host 12 also has a second host electromagnetic service connector component 20 provided on its front surface for a first device electromagnetic service connector component 22 provided on the adapter 16. In instances where the accessory device includes an incompatible electromagnetic service connector component, and the adapter 16 is used as an intermediate component to connect an accessory device 18 to a host 12, then adapter 16 will have a second device electromagnetic service connector component 23 for engagement with a device electromagnetic service connector component 21 of accessory device 18 as well as the first device electromagnetic service connector component 22 for connection with the host electromagnetic service connector component 20 of host 12. Therefore, device electromagnetic service connector component 22 may have the same general configuration whether included as part of accessory device 14 or adapter 16, and host electromagnetic service connector component 20 may have the same general configuration whether it couples directly with an accessory device or an adapter. Accordingly, for purposes of discussion, the various features and operation of electromagnetic service connector component 22 will hereinafter be described in connection with accessory device 14, but it shall be appreciated that exemplary device electromagnetic service connector component 22 may also be used in conjunction with adapter 16.

Host electromagnetic service connector component 20 may be integrally formed with host 12 or may be an add-on device. For purposes of discussion, host electromagnetic service connector component 20 is shown integrally formed with host 12. When configured as an add-on device, host electromagnetic service connector component 20 may also function as an adapter to enable a host and an accessory device having dissimilar electromagnetic service connector components to be indirectly coupled to one another. Host electromagnetic service connector component 20 may be removable or non-removable from host 12. Host electromagnetic service connector component 20 may be configured to transfer or receive a single electromagnetic service or multiple services.

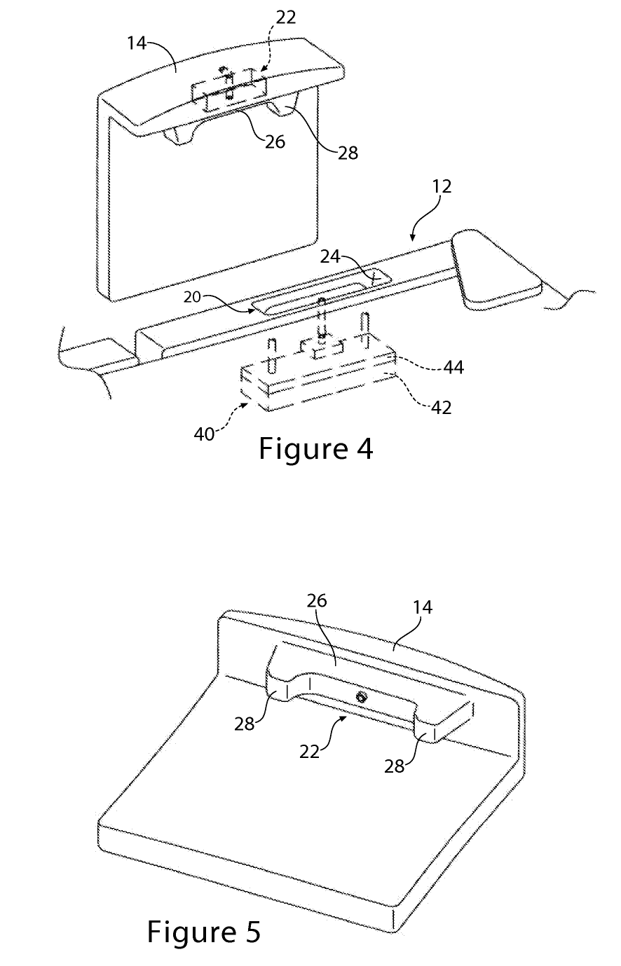

Referring to FIGS. 4 and 5, host electromagnetic service connector component 20 may be provided with a first electromagnetic service connection component, such as a receptacle, including a recess 24, proportioned to accept a second electromagnetic service connection component, such as a plug, extending from device electromagnetic service connector component 22. As best shown in FIG. 5, device electromagnetic service connector component 22 may be provided with ridges 28 to facilitate alignment of the electromagnetic service connector components. It will be appreciated that host electromagnetic service connector component 20 and device electromagnetic service connector component 22 may include various features to facilitate coupling of accessory device 14 to host 12. For example, ridges 28 are merely one example of the type of features that may be incorporated into host electromagnetic service connector component 20 and device electromagnetic service connector component 22 to aid alignment and coupling of accessory device 14 to host 12. In practice, other configurations may also be employed to accommodate various design considerations of a particular application.

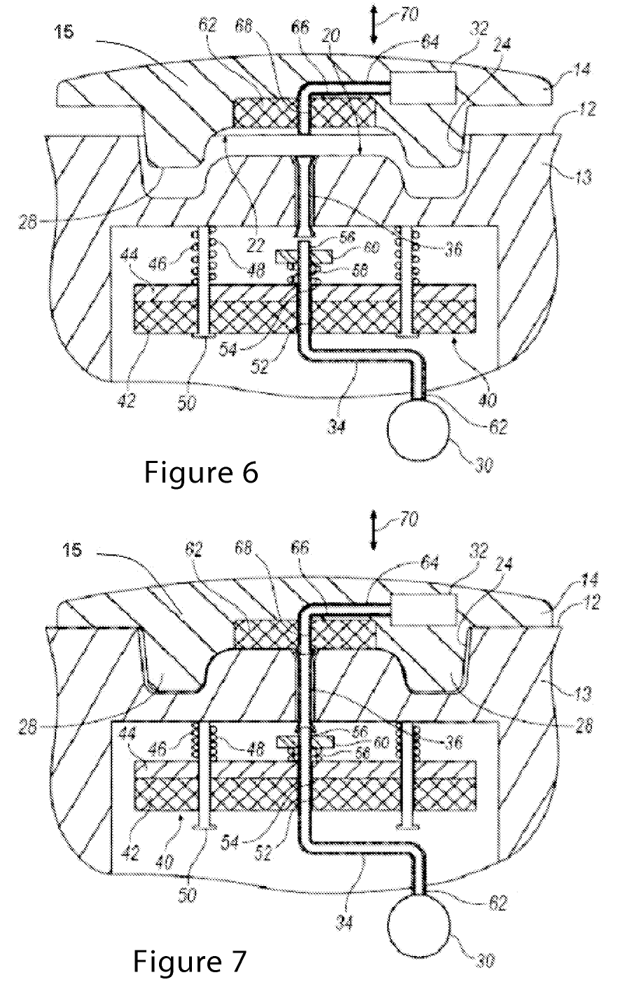

Referring to FIGS. 6 through 12 generally, host 12 may be provided with an electromagnetic service provider 30 to selectively provide an electromagnetic service to host electromagnetic service connector component 20 for delivery to electromagnetic service connector component 22. Accessory device 14 may similarly be provided with an electromagnetic service consumer 32 capable of using the electromagnetic service delivered to device electromagnetic service connector component 22. The various alternative embodiments illustrated in FIGS. 6 through 12 are illustrative of configurations for selectively facilitating the provision of electromagnetic service from electromagnetic service provider 30 to electromagnetic service consumer 32.

Device electromagnetic service connector component 22 may be integrally formed with accessory device 14 or may be an add-on component. For purposes of discussion, device electromagnetic service connector component 22 is shown in FIGS. 6 through 12 as being integrally formed with accessory device 14. When configured as an add-on component, device electromagnetic service connector component 22 may also function as an adapter to enable a host and an accessory device having dissimilar electromagnetic service connector components to be indirectly coupled to one another. Device electromagnetic service connector component 22 may be removable or non-removable from accessory device 14. Similarly, host electromagnetic service connector component 20 may be configured to transfer or receive a single electromagnetic service or multiple services.

As shown in particular in FIGS. 6 and 7, electromagnetic service provider 30 may be connected by way of an internal electromagnetic service line 34 to a location adjacent an external electromagnetic service line 36 extending through housing 13 of host 12. It should be noted that housing 13 may be an integral part of host 12 or may be a separate component. For purposes of discussion, housing 13 is illustrated as an integral part of host 12. Electromagnetic service lines 34 or 36 may be associated with an electromagnetic service switch 40 to selectively bring electromagnetic service lines 34 and 36 into engagement for the communication of an electromagnetic service therebetween.

For purposes of discussion, electromagnetic service lines 34 and 36 are illustrated generically as tube-like structures. The generically illustrated configuration is not intended to depict any particular configuration, but rather schematically represents a variety of potentially different configurations. In practice, the actual configuration will likely vary depending on, at least in part, the type of electromagnetic service being transferred, packaging requirements, and manufacturing considerations. For example, electromagnetic service lines 34 and 36 may be configured as electrical wire or cable when the electromagnetic service being transported is electric power and electromagnetic service switch 40 may bring electrical conductors of electromagnetic service line 34 into contact with the electrical conductors of electromagnetic service lines 36. This, of course, is merely one example of the various configurations that electromagnetic service lines 34 and 36 may include depending on the electromagnetic service involved. Nevertheless, it shall be appreciated that electromagnetic service lines 34 and 36 may include other configurations to accommodate various design considerations, including but not limited to, the type of electromagnetic service being provided.

More particularly, electromagnetic service switch 40 may include a proximity sensor such as a magnetic plate 42 backed by a non-magnetic plate 44 for strength and stability and movably mounted on two or more headed pins 46 to the housing 13 of the host 12. The magnetic plate 42 may be a made of a magnetized material or may be made of a material responsive to a magnetic force. Plate 44 may be manufactured of steel, plastic composite or other suitable material. One or more biasing members, such as coil springs 48 disposed about the pins 46, may be provided to bias the magnetic plates 42 and 44 against the heads 50 of the pins 46 and away from the electromagnetic service line 36. Internal electromagnetic service line 34 may be extended through apertures 52 and 54 through magnetic plate 42 and non-magnetic plate 44 to a location adjacent external electromagnetic service line 36. Distal end 56 of internal electromagnetic service line 34 may be biased in the direction of the external electromagnetic service line by a biasing member 58 such as a spring and may be provided with a feature 60, such as a connector or an insulating seal, depending on the type of electromagnetic service involved, to facilitate connection of distal end 56 with electromagnetic service line 36. It will be appreciated that internal electromagnetic service line 34 may have some flexibility to accommodate movement of distal end 56 while maintaining a reliable electrical connection to electromagnetic service provider 30.

Electromagnetic service switch 40 is movable between an open position illustrated in FIG. 6 and closed position illustrated in FIG. 7 to enable an electromagnetic service to be selectively transferred between host 12 and accessory device 14 when accessory device 14 is coupled to host 12. Electromagnetic service switch 40 is generally disposed in the open position when accessory device 14 is decoupled from host 12.

Accessory device 14 may be provided with a proximity target, such as a magnetic member 62 associated with device electromagnetic service connector component 22. An electromagnetic service line 64 may extend from electromagnetic service consumer 32 through a passageway 66 in housing 15 of accessory device 14 and an aperture 68 through magnetic member 62 and out of housing 15 to a location engageable with external electromagnetic service line 36 of host 12. It should be noted that housing 15 may be an integral part of accessory device 14 or may be a separate component. For purposes of discussion, housing 15 is illustrated as an integral part of accessory device 14. Operation of electromagnetic service switch 40 may be controlled by the action of magnetic member 62 in a manner described shortly below.

Similar to electromagnetic service lines 34 and 36, electromagnetic service line 64 is also illustrated generically as a tube-like structure, and is not intended to depict any particular configuration. In practice, electromagnetic service line 64 may have a variety of potentially different configurations depending on the type of electromagnetic service being transferred, as well as other design considerations.

With continued reference to FIGS. 6 and 7, the process of coupling and decoupling accessory device 14 with host 12 will now be described. Coupling of accessory device 14 to host 12 may be accomplished by positioning accessory device 14 adjacent host 12 in such a manner that device electromagnetic service connector component 22 is generally aligned with host electromagnetic service connector component 20, as shown in FIG. 6. Device electromagnetic service connector component 22 and host electromagnetic service connector component 20 may be coupled by generally moving accessory device 14 toward host 12 along path 70 until the two members are fully seated, as shown in FIG. 7. Ridges 28 on housing 15 guide electromagnetic service connector components 20 and 22 into engagement and bring external electromagnetic service line 36 of host 12 into engagement with electromagnetic service line 64 of accessory device 14.

At least one of magnetic plate 42 and magnetic member 62 is a magnet while the other may be formed of a magnetically responsive material or may be a magnet. When electromagnetic service connector components 20 and 22 are interengaged, magnetic member 62 acts as a proximity target for magnetic plate 42, which acts as a proximity sensor in a manner described below.

More particularly, in the illustrated structure of FIGS. 6 and 7, when electromagnetic service connector components 20 and 22 are spatially disposed such that the attractive magnetic force between magnetic member 62 and magnetic plate 42 overcomes the opposing force of springs 48, switch 40 begins to actuate such that magnetic plate 42 travels away from heads 50 of pins 46 and towards magnetic member 62. Once the travel has sufficiently progressed, distal end of 56 of internal electromagnetic service line 34 will be in engagement with external electromagnetic service line 36.

Thus, magnetic plate 42 of electromagnetic service switch 40 acts as a proximity sensor, detecting and reacting to magnetic member 62, acting as a proximity target, to bias the electromagnetic service lines into cooperative engagement and to thereby facilitate the flow of electromagnetic service from electromagnetic service provider 30 to electromagnetic service consumer 32. It should be noted that the placement of proximity sensor and proximity target relative to their spatial disposition to one another from their respective locations in the accessory device 14 and in the host 12, the proximity sensor's sensing sensitivity, and the proximity target's sensible signal may be designed such that the flow of electromagnetic service is inhibited until the components are within a desired spatial disposition range.

It is contemplated that either the proximity target or magnetic member 62 and the proximity sensor or magnet plate 42 may alternatively be formed of a non-magnetized material that is responsive to a magnet.

Biasing member 58 limits the movement of distal end 56 of internal electromagnetic service line 34 while maintaining a force that may be used to facilitate maintenance of a reliable contact and, where appropriate, a reliable seal between electromagnetic service lines 34 and 36.

Accessory device 14 may be decoupled from host 12 by reversing the previously described process for coupling the two devices. Separation of device electromagnetic service connector component 22 from host electromagnetic service connector component 20 moves magnetic member 62 away from magnetic plate 42 and releases electromagnetic service switch 40, permitting springs 48 to again disengage internal electromagnetic service line 34 from external electromagnetic service line 36.

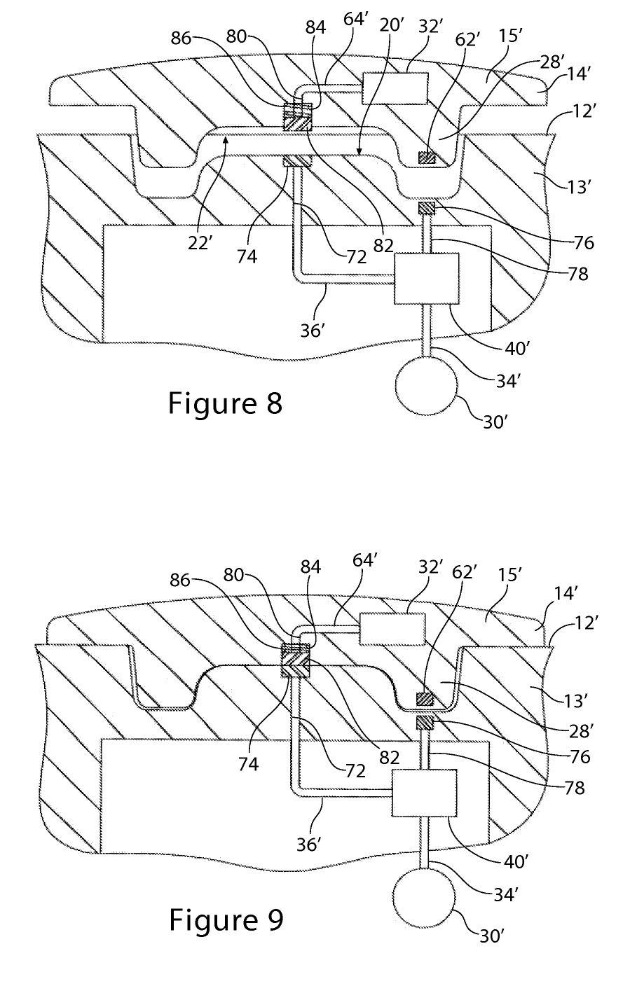

FIGS. 8 and 9 show a second embodiment of a modular system according to the invention comprising a host 12′ and an accessory device 14′, where elements in common with the first embodiment are denoted by the same reference numeral bearing a prime (′) symbol. Host 12′ may include an electromagnetic service provider 30′ connected by a first electromagnetic service line 34′ to an electromagnetic service switch 40′. A second electromagnetic service line 36′ extends from electromagnetic service switch 40′ through an aperture 72 in housing 13′ to a first interface 74. It will be appreciated that interface 74 may be one or more electrical contacts, a tube, or another type of interface depending on the electromagnetic service being provided by electromagnetic service lines 34′ and 36′. Electromagnetic service switch 40′ is associated with a proximity sensor 76 adapted to activate electromagnetic service switch 40′ to selectively permit the flow of an electromagnetic service from first electromagnetic service line 34′ to second electromagnetic service line 36′ in response to the detection of an appropriate proximity target. Proximity sensor 76 may be configured, for example, to sense a magnetic field, an electromagnetic or acoustic wave, a visual target, a temperature or a chemical. Proximity sensor 76 is connected to electromagnetic service switch 40′ by a line 78 to communicate to electromagnetic service switch 40′ the detection of an appropriate proximity target. The communication along line 78 may be, for example, by means of an electrical signal, an acoustic or electromagnetic wave, or a physical displacement of a linking member.

Accessory device 14′ may be provided with an electromagnetic service consumer 32′ connected by an electromagnetic service line 64′ through a passageway 80 in housing 15′ to a second interface 82 engageable with first interface 74. Accessory device 14′ may further be provided with a biasing member, such as a spring 84, that biases the second interface 82 partially through passageway 80. Accessory device 14′ is further provided with a proximity target 62′, which has a function similar to magnetic member 62 described above, chosen for cooperation with proximity sensor 76, which has a function similar to magnetic plate 42 described above.

Coupling of accessory device 14′ to host 12′ may be accomplished by positioning accessory device 14′ adjacent host 12′ in such a manner that device electromagnetic service connector component 22′ is generally aligned with host electromagnetic service connector component 20′, as shown in FIG. 8. When electromagnetic service connector components 20′ and 22′ are interengaged, as shown in FIG. 9, proximity target 62′ comes into the range of proximity sensor 76 and activates electromagnetic service switch 40′ to switch on the flow of electromagnetic service from electromagnetic service provider 30′ to electromagnetic service consumer 32′. Spring 84 limits the movement of second interface 82 against first interface 74 to facilitate a reliable contact and, where appropriate, a reliable seal between interfaces 74 and 82. Similarly, separation of device electromagnetic service connector component 22′ from host electromagnetic service connector component 20′ moves proximity target 62′ away from proximity sensor 76 and releases electromagnetic service switch 40′. Spring 84 may provide continued engagement of second interface 82 with first interface 74 accommodating a small amount of relative displacement between electromagnetic service electromagnetic service connector components 20′ and 22′.

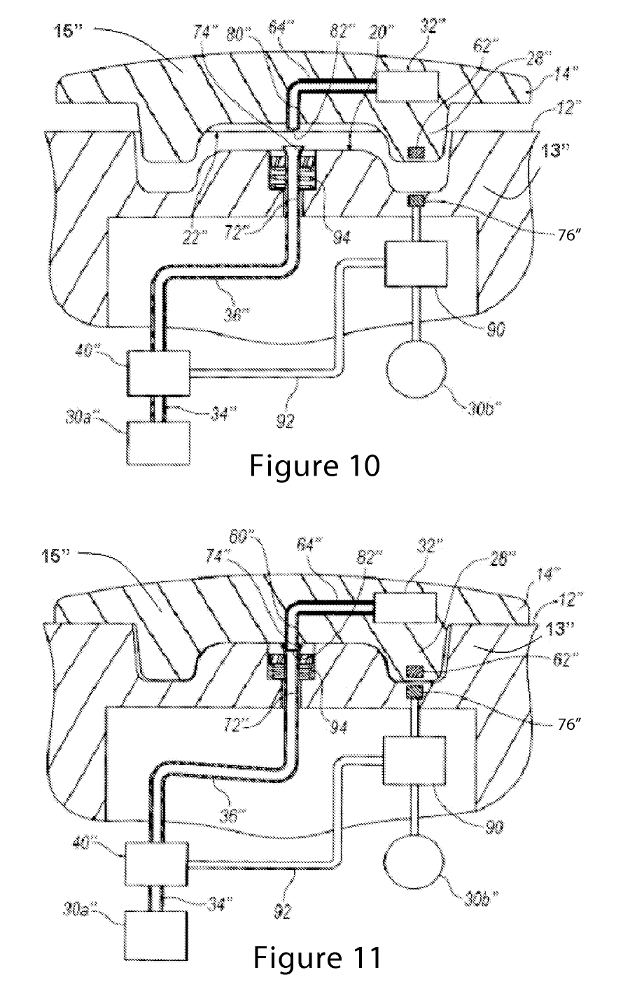

FIGS. 10 and 11 illustrate an approach to a switched electromagnetic service connector system wherein an electromagnetic service switch 40″ or a proximity sensor 76″ are powered independently of the electromagnetic service provider providing the electromagnetic service for the electromagnetic service consumer. In particular, host 12″ may include a first electromagnetic service provider 30a″ connected by a first electromagnetic service line 34″ to an electromagnetic service switch 40″. A second electromagnetic service line 36″ extends from electromagnetic service switch 40″ through an aperture 72″ in housing 13″ and terminates in a first interface 74″.

A proximity sensor 76″ is associated with a sender 90. Sender 90 is powered by a second electromagnetic service provider 30b″, such as an electrical power supply, and is connected to electromagnetic service switch 40″ by a line 92 to selectively activate electromagnetic service switch 40″ in response to the detection of an appropriate proximity target. The communication along line 92 may, for example, be by means of an electrical signal, an acoustic or electromagnetic wave, or a physical displacement of a linking member. Proximity sensor 76 may also be powered by second electromagnetic service provider 30b″ either directly or indirectly through sender 90.

Accessory device 14″ may be provided with an electromagnetic service consumer 32″ connected to an electromagnetic service line 64″ extending to passageway 80″ in housing 15 and terminating in a second interface 82″ engageable with first interface 74″. A biasing member 94, such as a spring, biases first interface 74″ toward second interface 82″. Accessory device 14″ is further provided with a proximity target 62″ chosen for cooperation with proximity sensor 76″.

Coupling of accessory device 14″ to host 12″ may be accomplished by positioning accessory device 14″ adjacent host 12″ in such a manner that device electromagnetic service connector component 22″ is generally aligned with host electromagnetic service connector component 20″, as shown in FIG. 10. When electromagnetic service connector components 20″ and 22″ are interengaged, as shown in FIG. 11, proximity target 62″ comes into the range of proximity sensor 76″ and activates electromagnetic service switch 40″ to switch on the flow of electromagnetic service from electromagnetic service provide a 30a″ to electromagnetic service consumer 32″. Spring 94 limits the movement of first interface 74″ against second interface 82″ to facilitate a reliable contact and, where appropriate, a reliable seal between interfaces 74″ and 82″. Similarly, separation of device electromagnetic service connector component 22″ from host electromagnetic service connector component 20″ moves proximity target 62″ away from proximity sensor 76″ and releases electromagnetic service switch 40″. Spring 94 may provide continued engagement of second interface 82″ with first interface 74″ accommodating a small amount of relative displacement between electromagnetic service electromagnetic service connector components 20″ and 22″.

As shown in FIGS. 10 and 11, first electromagnetic service provider 30a, electromagnetic service switch 40″, proximity sensor 76″, and sender 90 are illustrated as individual components. While not illustrated herein, an alternately embodiment may comprise these components combined or integrated into a single sensor-switch component.

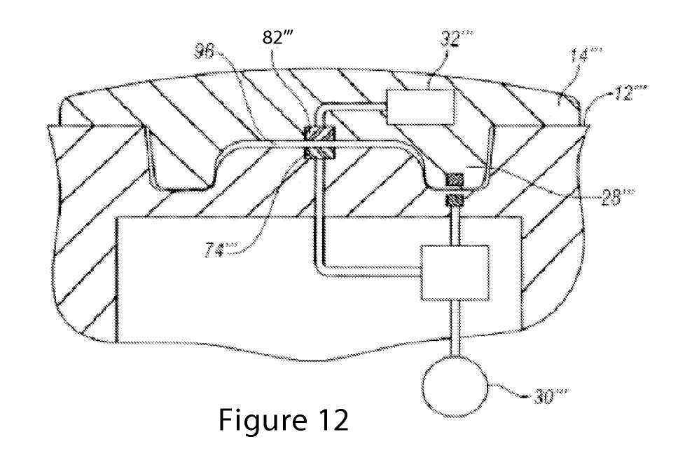

FIG. 12 shows a fourth embodiment of a modular system according to the invention comprising a host 12′″ and an accessory device 14′″, where elements in common with the first, second, or third embodiments are denoted by the same reference numeral bearing a triple prime (′″) symbol. FIG. 12 illustrates a switched electromagnetic service connector system similar to that illustrated in FIG. 8, except that the electromagnetic service delivered from first interface 74′″ to second interface 82′″ is delivered wirelessly or contactlessly. Therefore, no spring is required to be associated with either interface and it is acceptable to have a gap 96 between the interfaces when host 12′″ and device 14′″ are engaged.

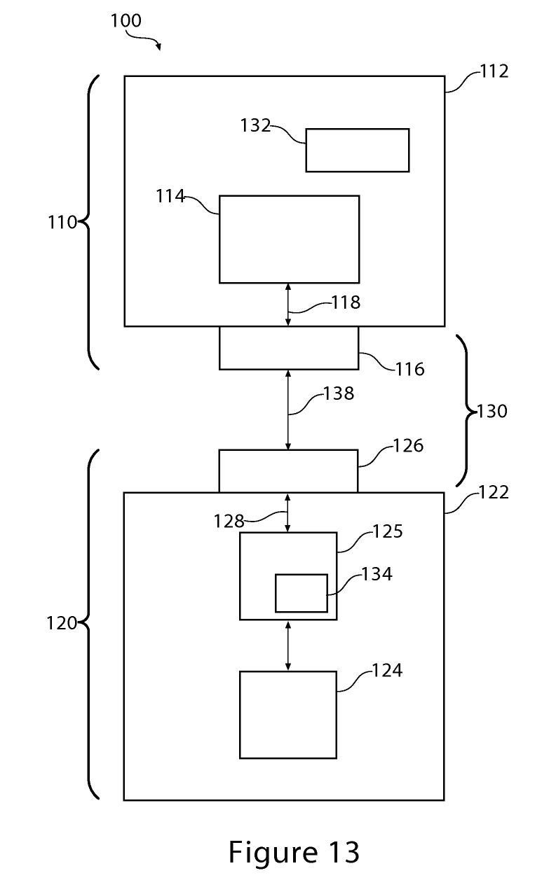

Referring now to FIG. 13, a more general example of an electromagnetic service provider and consumption system 100 is schematically illustrated. A first subsystem 110 is connectable to a second subsystem 120 for selectively transferring an electromagnetic service between subsystems 110 and 120. As illustrated, first subsystem 110 may include a functional device 112, such as a portable electronic device, including an electromagnetic service consumer 114 connected to a first electromagnetic service communication component 116, such as a plug, by an electromagnetic service line 118. Second subsystem 120 may include a host 122, such as a refrigerator, including an electromagnetic service provider 124 connected to a second electromagnetic service communication component 126, such as a receptacle, through an electromagnetic service switch 125 by electromagnetic service line 128.

A connector system 130, includes first electromagnetic service communication component 116 and second electromagnetic service communication component 126 which are selectively interengageable. A proximity target 132 and a proximity sensor 134 are respectively associated with first subsystem 110 and second subsystem 120 to selectively activate electromagnetic service switch 125 when first electromagnetic service communication component 116 and second electromagnetic service communication component 126 are engaged to permit the flow of the electromagnetic service from electromagnetic service provider 124 to second electromagnetic service communication component 126, so that it may subsequently be provided along an electromagnetic service line 138 between second electromagnetic service communication component 126 and first electromagnetic service communication component 116, and then along electromagnetic service line 118 to electromagnetic service consumer 114.

It will be appreciated that while host 122 is illustrated as including an electromagnetic service provider and functional device 112 is illustrated as including an electromagnetic service consumer, functional device 112 may alternatively or additionally include an electromagnetic service provider and host 122 may alternatively or additionally include an electromagnetic service consumer. It will further be appreciated that while first electromagnetic service communication component 116 is illustrated as being associated with electromagnetic service consumer 114 and second electromagnetic service communication component 126 is illustrated as being associated with electromagnetic service provider 124, it is contemplated that first electromagnetic service communication component 116 and second electromagnetic service communication component 126 may be male or female connector components so long as the components are capable of interengaging to permit the transfer of electromagnetic service therebetween.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. For example, while the above examples depict using magnets as a proximity target and a proximity sensor, it is appreciated that alternative types of proximity targets and proximity sensors, as defined herein, may be used. It is further anticipated and intended that future developments will occur in the arts discussed herein, and that the disclosed systems and methods will be incorporated into such future embodiments. In summary, it should be understood that the invention is capable of modification and variation and is limited only by the following claims.

All defined terms used in the claims are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system for coupling to an electromagnetic service communicating device comprising:
an electromagnetic service connector system comprising:
a first electromagnetic service connector component capable of being associated with an electromagnetic service communicating device and including a proximity target;
a second electromagnetic service connector component operably engageable with the first electromagnetic service connector component, the second electromagnetic service connector component capable of being associated with an electromagnetic service source and including a proximity sensor;
an electromagnetic service pathway between the first and second electromagnetic service connector components when the electromagnetic service components are interengaged, the electromagnetic service pathway being capable of passing an electromagnetic service between the first and second electromagnetic service connector components; and
an electromagnetic service switch operably associated with the proximity sensor to selectively permit the flow of the electromagnetic service along the electromagnetic service pathway when the proximity sensor detects the proximity target.

2. The system according to claim 1, wherein one of the first and second electromagnetic service connector components comprises an electromagnetic service plug and the other of the first and second electromagnetic service connector components comprises an electromagnetic service receptacle.

3. The system according to claim 1, wherein the electromagnetic service switch selectively permits the flow of electromagnetic service to the electromagnetic services pathway in response to the detection of the proximity target by the proximity sensor.

4. The system according to claim 1, wherein the electromagnetic service switch selectively forms the electromagnetic services pathway in response to the detection of the proximity target by the proximity sensor.

5. The system according to claim 4, wherein the electromagnetic service pathway comprises an electromagnetic service line for selectively transferring the electromagnetic service from the electromagnetic service source to the second electromagnetic service connector component, the electromagnetic service line being movable between a first position in which the electromagnetic service line is operably decoupled from the second electromagnetic service connector component and a second position in which the electromagnetic service line is operably coupled with the second electromagnetic service connector component, wherein the electromagnetic service line is arranged in the first position when the proximity sensor does not detect the proximity target.

6. The system according to claim 5 and further comprising a biasing member connected to the electromagnetic service line, wherein the biasing member urges the electromagnetic service line toward the first position.

7. The system according to claim 5, wherein the proximity target and the proximity sensor are magnetic, the electromagnetic service switch comprises the proximity sensor, and the proximity sensor responds to the detection of the proximity target by biasing the electromagnetic service line toward the second position.

8. The system according to claim 1, wherein the proximity target and the proximity sensor are magnetic and the electromagnetic service switch responds to movement of the proximity sensor in response to the detection of the proximity target by the proximity sensor.

9. The system according to claim 1 and further comprising a host configured to communicate at least one electromagnetic service to the electromagnetic service communicating device.

10. The system according to claim 9, wherein the host comprises at least one of a refrigerator, a freezer, a conventional oven, a microwave oven, a dishwashing machine, a stove, a range, an air conditioner, a dehumidifier, a clothes washing machine, a clothes dryer, a clothes refreshing machine, a non-aqueous washing apparatus, a water softener, a water heater, a furnace, pool water treatment equipment, an HVAC system, a thermostat, a blender, a mixer, a toaster, a coffee maker, an air purifier, an iron, a vacuum cleaner, a robot, a trash compactor and a structural feature of a building.

11. The system according to claim 10 and further comprising a portable functional device comprising the electromagnetic service communicating device.

12. The system according to claim 1 and further comprising a functional component including the electromagnetic service communicating device.

13. The system according to claim 1, wherein the proximity sensor is selected from a magnetic sensor, light sensor, optical sensor, eddy current sensor, acoustic sensor, electromagnetic sensor, chemical sensor and thermal sensor.

14. The system according to claim 1, wherein the proximity target is selected from a passive target and an active target.

15. The system according to claim 1, wherein the proximity sensor is selected from a passive sensor and an active sensor.

16. The system according to claim 1, wherein the electromagnetic service comprises at least one of electrical power and electronic data.

17. An electromagnetic service connector system for connecting a portable device to a host having a proximity target and an electromagnetic service source capable of supplying a service, the electromagnetic service connector system comprising:
an electromagnetic service connector component;
a proximity sensor capable of detecting the proximity target;
an electromagnetic service pathway interconnecting the electromagnetic service source and the electromagnetic service connector component; and
an electromagnetic service switch selectively permitting the flow of the electromagnetic service along the electromagnetic service pathway in response to detection of a proximity target by the proximity sensor.

18. The system according to claim 17, wherein the electromagnetic service connector system further comprises the electromagnetic service source.

19. The system according to claim 17, wherein the electromagnetic service connector component comprises at least one of an electromagnetic service plug and an electromagnetic service receptacle.

20. The system according to claim 17, wherein in the electromagnetic service switch selectively forms the electromagnetic service pathway in response to the detection of the proximity target by the proximity sensor.

21. The system according to claim 20, wherein the electromagnetic service pathway comprises an electromagnetic service line for selectively transferring the electromagnetic service from the electromagnetic service source to the electromagnetic service connector component, the electromagnetic service line being movable between a first position in which the electromagnetic service line is operably decoupled from the electromagnetic service connector component and a second position in which the electromagnetic service line is operably coupled with the electromagnetic service connector component, wherein the electromagnetic service line is arranged in the first position when the proximity sensor does not detect the proximity target.

22. The system according to claim 20 and further comprising a biasing member connected to the electromagnetic service line, wherein the biasing member urges the electromagnetic service pathway toward the first position.

23. The system according to claim 21, wherein at least one of the proximity target and the proximity sensor is magnetic, the electromagnetic service switch comprises the proximity sensor, and the proximity sensor responds to the detection of the proximity target by biasing the electromagnetic service line toward the second position.

24. The system according to claim 17, wherein the electromagnetic service switch responds to movement of the proximity sensor in response to the detection of the proximity target by the proximity sensor.

25. The system according to claim 24, wherein at least one of the proximity target and the proximity sensor is a magnet.

26. The system according to claim 17, wherein the proximity sensor responds to detection of the proximity target by sending a signal to the electromagnetic service switch.

27. The system according to claim 26 wherein the signal comprises at least one of a change in an electromagnetic field, an electromagnetic wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

28. The system according to claim 17, wherein the host comprises at least one of a refrigerator, a freezer, a conventional oven, a microwave oven, a dishwashing machine, a stove, a range, an air conditioner, a dehumidifier, a clothes washing machine, a clothes dryer, a clothes refreshing machine, a non-aqueous washing apparatus, a water softener, a water heater, a furnace, pool water treatment equipment, an HVAC system, a thermostat, a blender, a mixer, a toaster, a coffee maker, an air purifier, an iron, a vacuum cleaner, a robot, a trash compactor and a structural feature of a building.

29. The system according to claim 17, wherein the proximity sensor detects at least one of a change in an electromagnetic field, an electromagnetic wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

30. The system according to claim 17, wherein the electromagnetic service switch is powered by at least one of the electromagnetic service provider and a second electromagnetic service provider associated with the electromagnetic service switch and the proximity target.

31. The system according to claim 17, wherein the proximity target comprises a magnet, the proximity sensor comprises a magnet, and the electromagnetic service switch is powered at least partially by the magnetic interaction between the proximity sensor and the proximity target.

32. The system according to claim 31, wherein the electromagnetic service switch is powered by the mechanical movement of the proximity sensor in responsive to the magnetic interaction between the proximity sensor and the proximity target.

33. An electromagnetic service consumer for use in association with a host having an electromagnetic service provider, a first electromagnetic service connector component, and an electromagnetic service line selectively providing an electromagnetic service to the first electromagnetic service connector component in response to a proximity sensor of an electromagnetic service switch detecting a proximity target, the service consumer comprising:
a second electromagnetic service connector component;
an electromagnetic service pathway interconnected with the second electromagnetic service connector component; and
a proximity target capable of activating the proximity sensor to activate the electromagnetic service switch.

34. The service consumer according to claim 33 and further comprising a housing, wherein the second electromagnetic service connector component, the electromagnetic service pathway and the proximity target are each at least partially disposed with the housing.

35. The service consumer according to claim 33 and further comprising an adapter, wherein the service consumer further comprises a device capable of being removably coupled to the adapter.

36. The service consumer according to claim 35, wherein the service consumer is at least one of an accessory, a portable device, a consumer electronic device, a client software device, a remote user interface, a source of consumer information, a reader, a sensor device, a smart utensil, an appliance, an additional smart coupling device, a remote controller, a network binder, a cycle accessory, a resource controller, a communicator, an access system, a payment system, a sales demonstration device, and an electromagnetic service device.

37. The service consumer according to claim 33, wherein the proximity target provides at least one of a change in an electromagnetic field, an electromagnetic wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and the presence of a chemical.

38. The service consumer according to claim 33, wherein the proximity target is selected from a passive target and an active target.

39. The service consumer according to claim 33, wherein the proximity target is a magnet.

40. An adapter for removably coupling a portable electromagnetic service communicating device having a first device electromagnetic service connector component to a host electromagnetic service communicating device having a first host electromagnetic service connector component that cannot be directly connected to the first device electromagnetic service connector component and a first contactless proximity coupling device, the adapter comprising:
a second host electromagnetic service connector component engageable with the first host electromagnetic service connector component;
a second device electromagnetic service connector component engageable with the first device electromagnetic service connector component;
an electromagnetic service pathway interconnecting the second host electromagnetic service connector component and the second device electromagnetic service connector component for the transfer of an electromagnetic service therealong; and
a second contactless proximity coupling device operably associated with the second host electromagnetic connector component, the second contactless proximity coupling device being configured to engage the first contact proximity coupling device when the first and second electromagnetic connector components are engaged to selectively permit the communication of the electromagnetic service between the first electromagnetic communicating device and the second electromagnetic service communicating device.

41. The adapter according to claim 40 wherein the first contactless proximity coupling device comprises a proximity sensor and an electromagnetic service switch selectively providing an electromagnetic service between the host electromagnetic service connector components in response to the proximity sensor engaging a proximity target, and the second contactless proximity coupling device comprises a proximity target capable of engaging the proximity sensor to actuate the electromagnetic service switch.

42. The adapter according to claim 41, wherein the proximity target provides at least one of a change in an electromagnetic field, an electromagnetic wave, an acoustic wave, a visual target, an optical signal, a light wave, a chemical component, an electrical signal, a change in voltage, a change in current, a change in frequency, a change in resistance, a change in inductance, a change in capacitance, a mechanical signal, a change in pressure, a displacement, a vibration, and a presence of a chemical.

43. The adapter device according to claim 41, wherein the proximity target is selected from a passive target and an active target.
